(19) United States
(12) Patent Application Publication
(10) Pub. No.: US 2016/0001886 A1
(43) Pub. Date: Jan. 7, 2016

(54) AIRCRAFT SEAT COVER AND AIRCRAFT DIVAN EQUIPPED WITH SAME

(71) Applicant: PAM FULLERTON, VERDUN (CA)

(72) Inventor: PAM FULLERTON, VERDUN (CA)

(21) Appl. No.: 14/323,439

(22) Filed: Jul. 3, 2014

(51) Int. Cl. B64D 11/06; A47C 7/02

(52) U.S. Cl. CPC B64D 11/0647; B64D 11/0641; A47C 7/021

(57) ABSTRACT

A comfort seat cushion cover for installation over a seat cushion of a 16G certified divan when at cruising altitude. The seat cushion cover receives the seat cushion in an opening and retains it securely therein. The cover improves comfort and extends a depth of the divan while maintaining the 16G certification.

### FIELD OF THE INVENTION

The present invention relates to an aircraft seat cover and an aircraft divan equipped with the same. In particular, the present invention relates to a comfort seat cover for improving the comfort of a 16G type aircraft divan while allowing it to retain its 16G certification.

### BACKGROUND

In keeping with a progressive accident protection approach, modern certified transport aircraft must meet a variety of safety standards prior to their certification. In this regard, and in order to improve the survival of passengers and other occupants the 16G dynamic standard was developed. The 16G dynamic standard requires that seating including divans is tested in a manner which simulates the loads that might be expected during a survivable accident. Two dynamic loads are simulated, a first in which the loads are predominantly vertically downwards and a second in which the loads are predominantly in a forward direction. The greatest loads are experienced in the forward direction at about 16 gs. Seats and divans which meet the specification are typically referred to as 16G certified.

The 16G testing procedure requires crash testing the seats and divans in a simulated aircraft environment and with a deceleration from 44 feet/sec to stop in no more than 0.09 seconds, giving a peak deceleration of at least 16 gs. Test dummies equipped with accelerometers and the like are restrained in the seats and divans during the tests and accelerations measured. For example, accelerations used in calculating the risk of head injury are collected. In order for a seat to meet the 16G standard, the test dummy must be subject to only acceptable levels of injury, for example through the contact with other seats or structures. The test must also indicate that the seats protect the occupant from leg and spine injuries (for example, less than 1500 lbs lumbar load), are adequately fastened to the airframe and do not deform excessively on impact (which might lead to occupants becoming trapped within the aircraft).

In order to be 16G certified, seats and divans therefore are subject to rigorous testing. The testing impacts not only the frame of the seats and divans but also their upholstery. Indeed, in order to meet the 16G requirement Applicant has noted that the seat or divan and harness assembly must hinder the occupant from sliding out from under the lap belt (known as “submarining”). Additionally, Applicant has noted that cushioning materials tend to amplify spine loads. As a result, especially for divans, monolithic single density/single layer foams are used which are able to withstand the structural compression test. These materials are typically quite firm and although initially adequately comfortable Applicant has noted that they can become uncomfortable if sat in for an extended period of time, which is typically the case as such 16G certified aircraft are typically long range aircraft which may remain at cruising altitude for over ten (10) hours. Applicant has also noted that the 16G standard must be maintained during taxi, take-off and on final approach/landing. However, during cruise loose equipment may be added to the 16G seat/divan to improve its comfort.

Additionally, Applicant has noted that the in order to maintain aisle clearances and the like 16G divans are not as deep as conventional divans.

### SUMMARY OF THE INVENTION

In order to address the above and other drawbacks, there is provided a seat assembly comprising a 16G certified divan mountable in an aircraft and comprising a plurality of substantially cuboid seat cushions, a comfort seat cushion cover for snug removeable installation over at least one of the plurality of cuboid seat cushions, the cover comprising a seat depth extending cushioning front panel, a pliant fabric or leather rear panel and a pair of like opposed pliant fabric or leather side panels each spanning a space between a respective edge of the front panel and a respective edge of the back panel, the panels combining to define a seat cushion receiving opening there between, and a cushioning seat panel spanning the seat cushion receiving opening and an upper edge of the cushioning front panel, the cushioning seat panel secured towards its front outer edge to a top of the cushioning front panel and towards each of the side outer edges to an upper edge of a respective one of the side panels, the cushioning front panel comprising a foam core covered in a fabric or leather, the upholstered upper panel comprising a fabric or leather outer and a soft filling. When the comfort seat cushion cover is placed over the at least one cuboid seat cushion, at least the front and side panels extend to or below a bottom of the cuboid seat cushion and such that the cuboid seat cushion is substantially no longer visible.

There is also provided a comfort seat cushion cover for assembly with a 16G certified divan mountable in an aircraft and comprising a plurality of substantially cuboid seat cushions. The cover comprises a seat depth extending cushioning front panel comprising a foam core covered in a fabric or leather, a pliant fabric or leather rear panel and a pair of like opposed pliant fabric or leather side panels each spanning a space between a respective edge of the front panel and a respective edge of the back panel, the panels combining to define a seat cushion receiving opening there between, and an upholstered cushioning seat panel spanning the seat cushion receiving opening and an upper edge of the cushioning front panel, the cushioning seat panel secured towards its front outer edge to a top of the cushioning front panel and towards each of the side outer edges to an upper edge of a respective one of the side panels, the upholstered cushioning seat panel comprising a fabric or leather outer and a soft filling. When the comfort seat cushion cover is placed over the at least one cuboid seat cushion, at least the front and side panels extend to or below a bottom of the cuboid seat cushion and such that the cuboid seat cushion is substantially no longer visible.

### BRIEF DESCRIPTION OF THE DRAWINGS

FIG. 1 provides a right front view of a seat assembly in accordance with an illustrative embodiment of the present invention;

FIG. 2 provides a partial sectional view along line II-II in FIG. 1;

FIG. 3 provides an exploded view of a comfort seat cushion cover in accordance with an illustrative embodiment of the present invention;

FIGS. 4A and 4B provide an illustration of a comfort seat cushion cover being installed (FIG. 4A) and installed (FIG. 4B) on a 16G seat cushion and in accordance with an illustrative embodiment of the present invention;

FIGS. 5A through 5E provide respectively front, back, side bottom and top views of a comfort seat cushion cover and in accordance with an illustrative embodiment of the present invention;

FIG. 6 provides an exploded view of a comfort back cushion cover in accordance with an illustrative embodiment of the present invention;

FIG. 7 provides an illustration of a comfort back cushion cover being installed on a 16G back cushion and in accordance with an illustrative embodiment of the present invention; and

FIGS. 8A through 8E provide respectively top, bottom, side back and front views of a comfort back cushion cover and in accordance with an illustrative embodiment of the present invention.

### DETAILED DESCRIPTION OF THE ILLUSTRATIVE EMBODIMENTS

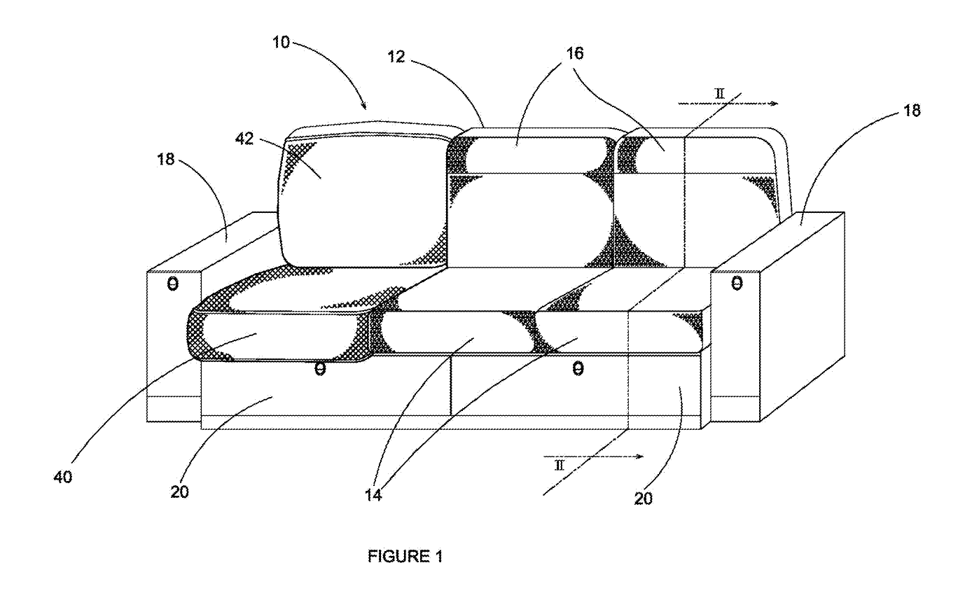

Referring now to FIG. 1, a seat assembly in accordance with an illustrative embodiment of the present invention will now be described. The seat assembly, generally to be the reference numeral 10 comprises a 16G certified divan 12 comprising a plurality of substantially cuboid seat cushions as in 14 and back cushions as in 16 mounted to a supporting frame (not shown). The 16G certified divan 12 typically also includes arm rests as in 18. A storage compartment 20 may be provided under the divan 12 for convenient storage of articles such as safety equipment and life rafts or the like. The arm rests as in 18 also function as cabinets and provide for convenient storage of loose articles, especially during take-off and landing.

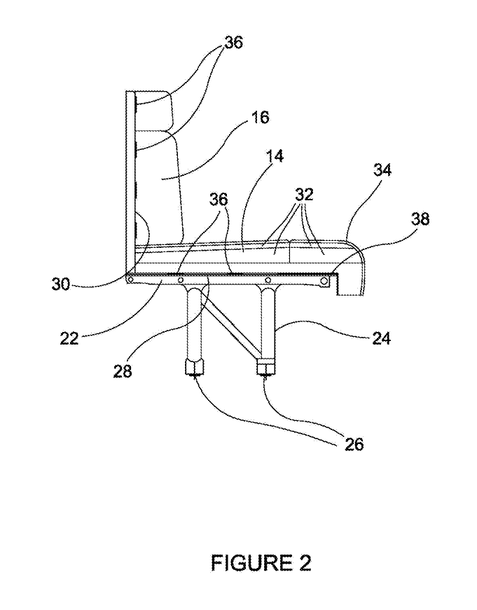

Referring to FIG. 2 in addition to FIG. 1, the divan 12 further comprises a supporting frame or bench 22 comprising a plurality of legs as in 24. The supporting bench 22 is typically manufactured from a light resilient material such as aluminum or carbon fiber or the like and the legs 24 of the frame are secured to the airframe by bolts 26 or the like to prevent movement. The bench further comprises a substantially flat bench seat 28 and back rest 30 which may be covered in a fabric or the like (not shown). In a berthable embodiment of the divan 12, the frame 22 includes the requisite linkage or the like (not shown) allowing the bench seat 28 to be moved outward while simultaneously tilting the back rest 30 and such that the bench seat 28 and back rest 30 in combination with their respective cushions 14, 16 form a flat, bed-like surface.

Still referring to FIG. 2, the cushions 14, 16 of the 16G certified divan 12 are manufactured from of materials such as layers of highly flame resistant polyurethane foam 32 of different firmness which are shaped and combined with an adhesive to provide a given cushion shape. The lower foam layers are also chosen to improve flotation. The layers of foam are covered with a robust textile or leather 34. The seat cushions 14 are removeably secured to the bench seat 28 and the back cushions 16 are secured to the back rest 30 by strips of a hook and loop type fastener 36, such as Velcro™, such that they may be removed, for example in an emergency situation to serve as a flotation device. A support angle 38 manufactured from a strong rigid material such as metal may also be provided to add additional support along the forward edge of the divan 12.

Referring back to FIG. 1, the seat assembly 10 also comprises at least one comfort seat cushion cover 40 and may also include at least one comfort back cushion cover 42. As will be discussed in more detail below, the cushion covers as in 40, 42 are removeable such that they may be removed from the 16G certified divan 12 during taxing, take off, approach and landing (and stowed as loose equipment) and easily installed, for example once the cruise portion of a flight has been reached. Of note is that although only one seat cushion 14 and one back cushion 16 are shown including an additional comfort seat cushion cover 40 and comfort back cushion cover 42, in a typical embodiment all cushions as in 14, 16 would be equipped with such covers.

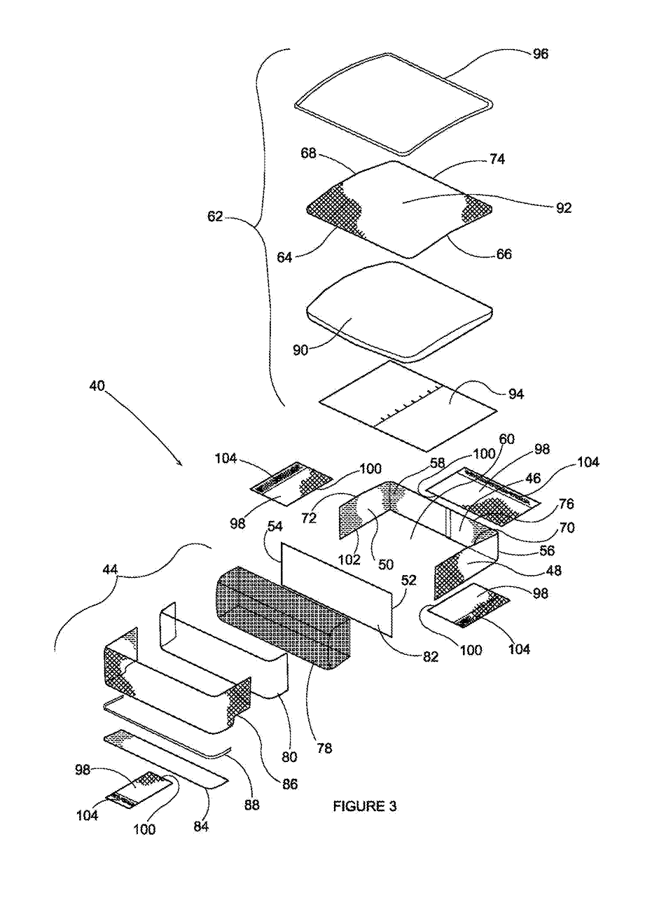

Referring now to FIG. 3, the seat cushion cover 40 comprises a seat depth extending cushioning front panel assembly 44, a pliant fabric or leather rear panel 46 and a pair of like opposed pliant fabric or leather side panels 48, 50. Each of the side panels as in 48, 50 span a space between a respective edge 52, 54 of said front panel 44 and a respective edge of said back panel 56, 58, to which they are secured, for example by sewing or the like. In a particular embodiment the side panels 48, 50 and rear panel 46 are manufactured from two long panels, each long panel forming a respective one of the side panels 48, 50 and a respective half of the rear panel 46, with the two long panels being attached along a seam towards the center of the rear panel 46. The panels 44, 46, 48, 50 combine to define a seat cushion receiving opening 60 there between. The seat cushion cover 40 further comprises a cushioning seat panel 62 spanning the upper outlet of the seat cushion receiving opening 60 and an upper edge of the cushioning front panel 44. The cushioning seat panel 62 is secured towards its front outer edge 64 to a top of the cushioning front panel 44, for example by sewing or an adhesive or the like, and towards each of the side outer edges 66, 68 to a respective upper edge 70, 72 of a respective one of the side panels 48, 50. Additionally, the cushioning seat panel 62 may be secured along its rearward edge 74 to an upper edge 76 of the rear panel 46, again for example by sewing or an adhesive or the like.

Still referring to FIG. 3, the cushioning front panel assembly 44 comprises a foam core 78 manufactured from an aviation type urethane seating foam and may also include a soft filling 80, such as goose down, a combination goose down/feather filling or synthetic hypoallergenic microfiber down filling and combinations thereof, to add additional comfort. The foam core 78 and soft filling 80 are encased in a fabric and/or leather outer comprising a fabric back panel 82, a fabric or leather bottom panel 84 and a fabric or leather front panel 86. As will be seen below, a portion of the foam core 78 and soft filling 80 are encased by the forward end of the cushioning seat panel 62. Welt trim 88 can be added to the front panel assembly 44 to improve durability and provide accent. The front panel assembly 44 can be used to extend the depth of the divan 12 between 2 to 5 inches and such that it provides a wider surface more in accordance with a conventional divan and for more comfortable lounging and sleeping or the like, yet while still allowing the divan 12 to maintain its conformance with the 16G certification during taxing, takeoff and landing. In the berthable embodiment of the divan 12 as discussed above, and given the relative proximity between the divan 12 and other seats (not shown) on board the aircraft, the front panel assembly 44 is selected to ensure an extended depth of no more than about 3.5 inches, and such that when the divan 12 is berthed it does not interfere with an adjacent seat or divan. In a particular embodiment a plurality of different cushioning seat panels as in 40 with differing front panel assembly depths could be provided to accommodate different configurations.

Still referring to FIG. 3, the cushioning seat panel 62 is comprised of a soft filling 90, such as goose down, a combination goose down/feather filling or synthetic hypoallergenic microfiber down filling and combinations thereof, encased in the pocket between a fabric or leather outer 92 and a fabric backing 94. Welt trim 96 can be added to the cushioning seat panel 62 to improve durability and provide accent. As discussed above, when assembled the cushioning seat panel 62 spans the seat cushion receiving opening 60 and an upper edge of the cushioning front panel 44. In a particular embodiment the fabric backing 94 is fabricated from two (2) pieces of fabric and includes a closable flap such as using Velcro™ or a zipper or the like separating the two pieces and allowing access to the soft filling 90, such that the filling 90 may be removed from the pocket for cleaning or replacement or the like.

Still referring to FIG. 3, as will be discussed in more detail below, securing flaps as in 98 are provided each which are secured along a first edge 100 to a lower edge as in 102 of a respective front, side or rear panel, for example by sewing or the like. The flaps as in 98 are manufactured from a pliant fabric or leather or the like and each comprise a strip 104 of a loop and hook type fastener such as Velcro™.

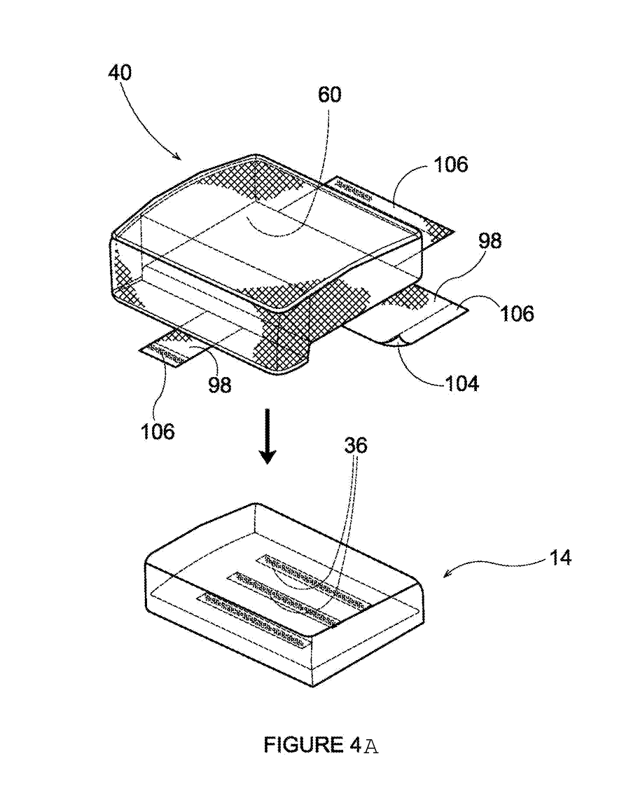

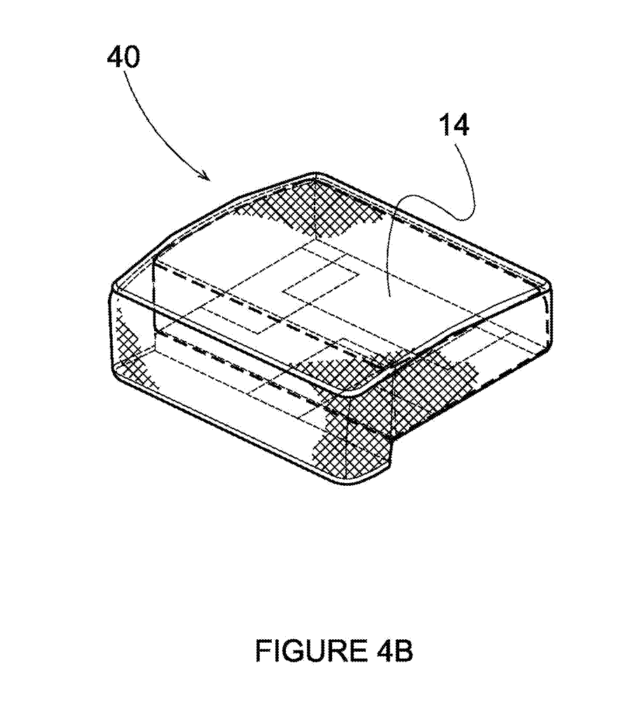

Referring now to FIG. 4A and FIG. 4B, in order to install the cushioning seat panel 40 on the divan 12 and once the aircraft has reached cruising altitude, a selected seat cushion as in 14 is removed from the divan 12 and the cushioning seat panel 40 placed over the seat cushion 14 and such that the seat cushion 14 is received within the seat cushion receiving opening 60. The securing flaps as in 98 are then folded underneath the seat cushion 14 and such that each Velcro™ strip as in 104 is at least partially engaged by at least one of the Velcro™ strips as in 36 (FIG. 4B). In this manner the seat cushion 14 is snuggly secured to the cushioning seat panel 40, limiting the seat panel's movement. The panel/cushion assembly can then be reassembled to the frame 22 of the divan 12 in the conventional manner. Of note is that the front panel assembly 44 and the side panels 48, 50 encase the cushion 14 such that when the cushion/cover assembly is installed on the frame 22, the cushion 14 is no longer visible, thereby improving the overall look of the assembly.

Still referring to FIG. 4A, in a first embodiment, the securing flaps as in 98 are short enough such that a portion of the Velcro™ strips as in 36 remain exposed when the securing flaps 98 are positioned against the underside of the cushion 14. This allows the panel/cushion assembly to be resecured to the frame 22 of the divan 12 using the exposed portions of the Velcro™ strips as in 36. In a second embodiment, the securing flaps as in 98 include an additional Velcro™ strip on the outside, and such that when the securing flaps as in 98 are folded underneath the cushion 14, a second strip of Velcro™ 106 is positioned on the outside of the flaps as in 98 and such that it can be engaged by the complementary Velcro™ strips on the frame 22. In this embodiment the securing flaps as in 98 may cover the entire underside of the cushion 14.

Referring back to FIG. 1, the comfort seat cushion cover 40 and the back cushion cover as in 42 are both manufactured from light pliable materials and such that they can be readily folded and stowed as loose equipment during taxiing, takeoff and landing.

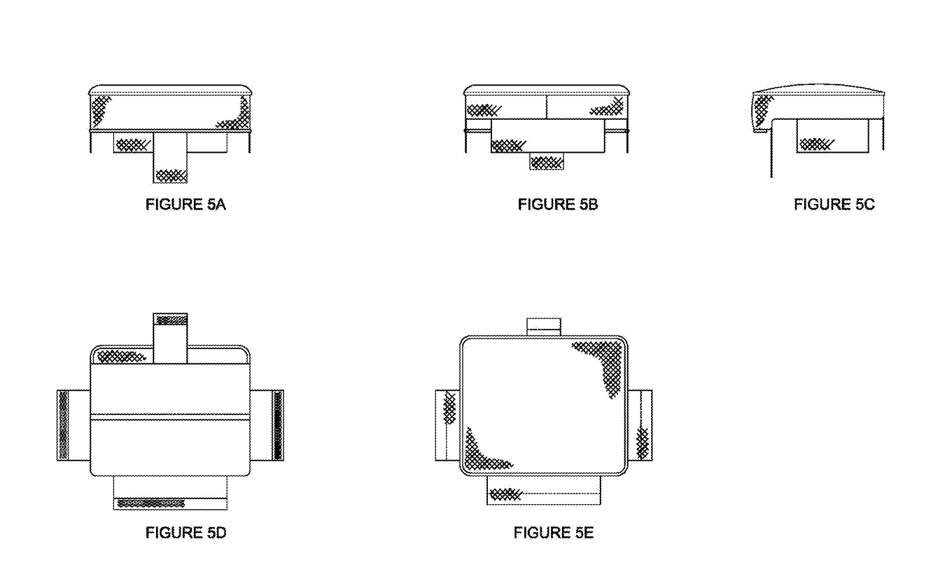

Referring now to FIGS. 5A though 5E, different views of the cushioning seat panel 40 are provided.

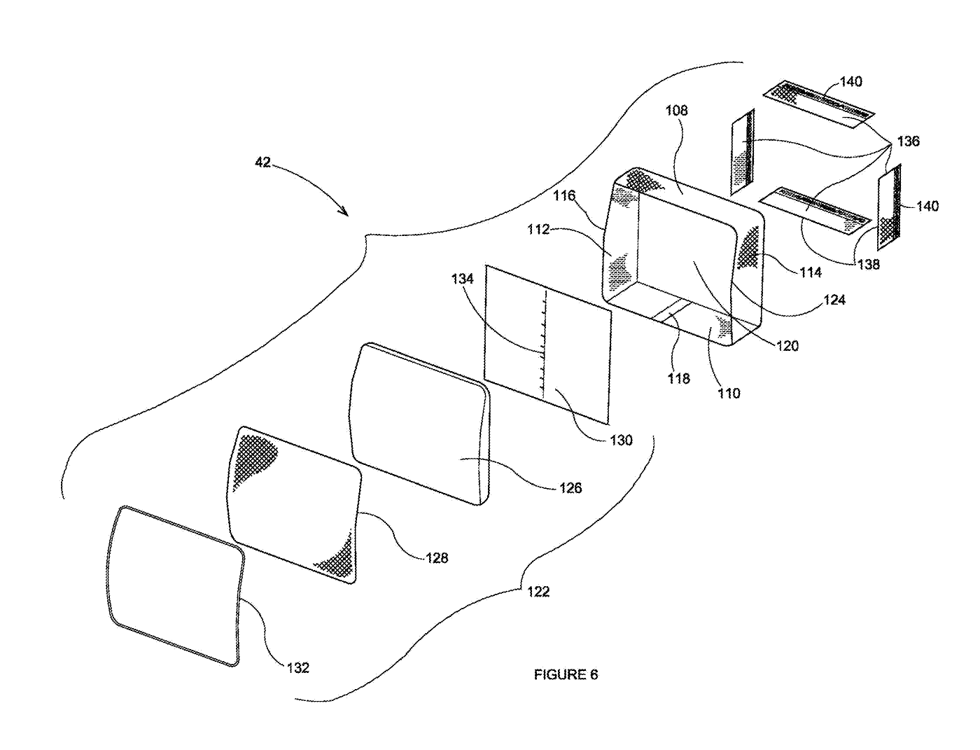

Referring now to FIG. 6, the back cushion cover 42 comprises a pliant fabric or leather top panel 108, a pliant fabric or leather bottom panel 110 and a pair of like opposed pliant fabric or leather side panels 112, 114. The panels 108, 110, 112, 114 are illustratively formed from a single piece of pliant fabric or leather which is attached into a panel assembly 116 at a join 118 using a stitch or adhesive or the like. The panels 108, 110, 112, 114 combine to define a back cushion receiving opening 120 there between. The back cushion cover 42 further comprises a cushioning back panel 122 spanning the front of the back cushion receiving opening 120. The cushioning back cushion cover panel 122 is secured towards its perimeter to a forward edge 124 of the panel assembly 116, for example by sewing or an adhesive or the like.

Still referring to FIG. 6, the cushioning back panel 122 is comprised of a soft filling 126, such as goose down, a combination goose down/feather filling or synthetic hypoallergenic microfiber down filling and combinations thereof, encased in the pocket between a fabric or leather outer 128 and a fabric backing 130. Welt trim 132 can be added to the cushioning back panel 122 to improve durability and provide accent. When assembled, the cushioning back panel 122 spans the back cushion receiving opening 120. In a particular embodiment the fabric backing 130 is fabricated from two (2) pieces of fabric and includes a closable flap 134 such as using Velcro™ or a zipper or the like separating the two pieces and allowing access to the soft filling 126, such that the filling 126 may be removed from the pocket for cleaning or replacement or the like. Securing flaps as in 136 are provided each which are secured along a front edge 138 about a rearward perimeter of the panel assembly 116 and adjacent a respective one of the panels 108, 110, 112, 114, for example by sewing or an adhesive or the like. The flaps as in 136 are manufactured from a pliant fabric or leather or the like and each comprise a strip 140 of a loop and hook type fastener such as Velcro™.

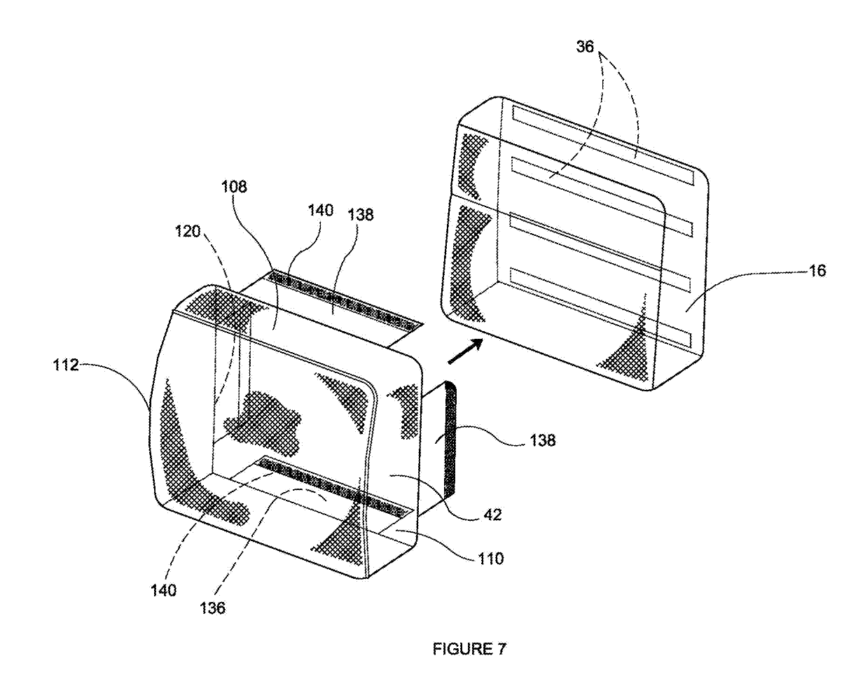

Referring now to FIG. 7, in order to install the cushioning back panel 42 on the divan 12 and once the aircraft has reached cruising altitude, a selected back cushion as in 16 is removed from the divan 12 and the cushioning back panel 42 placed over the back cushion 16 and such that the back cushion 16 is received within the back cushion receiving opening 120. The securing flaps as in 136 are then folded behind the back cushion 16 and such that each Velcro™ strip as in 140 is at least partially engaged by at least one of the Velcro™ strips as in 32. In this manner the back cushion 16 is snuggly secured to the cushioning back panel 42, limiting the back panel's movement. The panel/cushion assembly can then be reassembled to the frame 22 of the divan 12 in the conventional manner. Of note is that the top panel 108 and side panels 110, 112 encase the cushion 16 such that when the assembly is installed on the frame 22, the cushion 16 is no longer visible, thereby improving the overall look of the assembly.

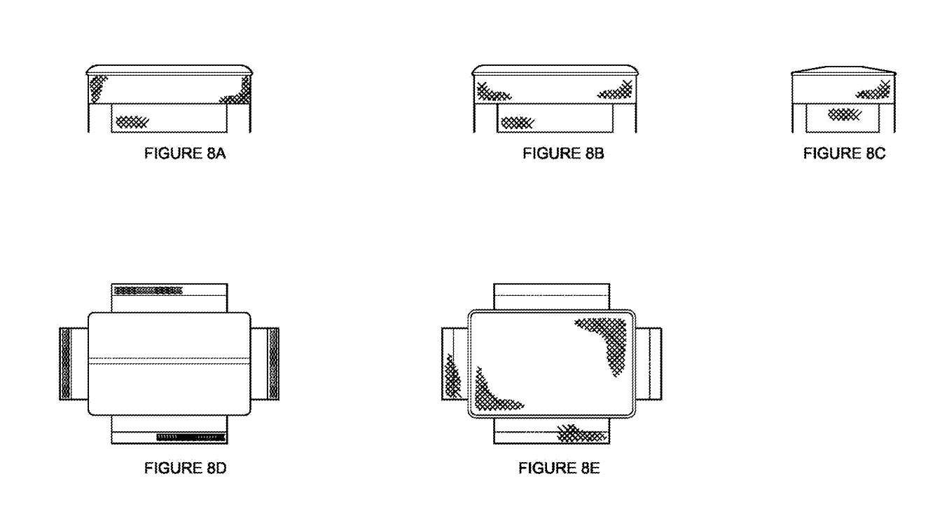

Referring now to FIGS. 8A though 8E, different views of the cushioning seat panel 42 are provided.

Although the present invention has been described hereinabove by way of specific embodiments thereof, it can be modified, without departing from the spirit and nature of the subject invention as defined in the appended claims.

We claim:

1. A seat assembly comprising:
a 16G certified divan mountable in an aircraft and comprising a plurality of substantially cuboid seat cushions;
a comfort seat cushion cover for snug removeable installation over at least one of said plurality of cuboid seat cushions, said cover comprising a seat depth extending cushioning front panel, a pliant fabric or leather rear panel and a pair of like opposed pliant fabric or leather side panels each spanning a space between a respective edge of said front panel and a respective edge of said back panel, said panels combining to define a seat cushion receiving opening there between, and a cushioning seat panel spanning said seat cushion receiving opening and an upper edge of said cushioning front panel, said cushioning seat panel secured towards its front outer edge to a top of said cushioning front panel and towards each of said side outer edges to an upper edge of a respective one of said side panels, said cushioning front panel comprising a foam core covered in a fabric or leather, said upholstered upper panel comprising a fabric or leather outer and a soft filling;
wherein when said comfort seat cushion cover is placed over said at least one cuboid seat cushion, at least said front and side panels extend to or below a bottom of said cuboid seat cushion and such that the cuboid seat cushion is substantially no longer visible.

2. The seat assembly of claim 1, wherein said seat depth extending cushioning front panel is selected to extend a depth of said seat assembly from between 2 inches and 5 inches.

3. The seat assembly of claim 2, wherein said seat depth extending cushioning front panel is selected to extend a depth of said seat assembly to a maximum of 3.5 inches.

4. The seat assembly of claim 1, wherein said soft filling is selected from a group comprising goose down, a feather filling, a synthetic hypoallergenic microfiber down filling and combinations thereof.

5. The seat assembly of claim 1, wherein said divan comprises three (3) substantially cuboid seat cushions and three (3) comfort seat cushion covers, one of each of said seat cushion covers installed on a respective one of said cuboid seat cushions.

6. The seat assembly of claim 1, wherein said cushioning seat panel is secured towards a rear outer edge to an upper edge of said back panel.

7. The seat assembly of claim 1, wherein said seat assembly further comprises a cuboid back cushion and further comprising a back comfort cushion cover for snug installation over said cuboid back cushion, said cover comprising a pliant fabric or leather rear panel bottom panel, a pliant fabric or leather top panel and a pair of like opposed pliant fabric or leather second side panels each spanning a space between a respective side edge of said bottom panel and a respective side edge of said top panel, said panels combining to define a back cushion receiving opening there between, and a cushioning back panel spanning said back cushion receiving opening, said bottom panel secured towards its outer edges to a forward edge of each of said lower, second side and top panels, said cushioning back panel comprising a fabric or leather outer and a soft filling wherein when said comfort back cushion cover is placed over said back cushion, at least said top and second side panels extend to or below a back of said back cushion and such that the back cushion is substantially no longer visible.

8. The seat assembly of claim 1, further comprising a releasable fastener for securely fastening said seat comfort cushion cover to said seat cushion.

9. The seat assembly of claim 8, wherein said fastener comprises a two component hook and loop type fastener, wherein a first of said two components is attached to an underside of said seat cushion and a second of said two components is attached to a flap extending from a lower edge of each of said panels and further wherein said second components are engaged by said first components following insertion of said seat cushion into said seat cushion receiving opening and folding each of said flaps over an underside of said seat cushion.

10. The seat assembly of claim 8, wherein said comfort seat cushion cover/cushion assembly is secured to a frame of said divan using a two component hook and loop type fastener.

11. The seat assembly of claim 7, further comprising a fastener for securely fastening said back comfort cushion cover to said back cushion.

12. The seat assembly of claim 11, wherein said fastener comprises a two component hook and loop type fastener wherein a first of said two components is attached to a backside of said back cushion and a second of said two components is attached to a flap extending from a rearward edge of each of said panels and further wherein said second components are engaged by said first components following insertion of said back cushion into said back cushion receiving opening.

13. A comfort seat cushion cover for assembly with a 16G certified divan mountable in an aircraft and comprising a plurality of substantially cuboid seat cushions, the cover comprising:
a seat depth extending cushioning front panel comprising a foam core covered in a fabric or leather;
a pliant fabric or leather rear panel and a pair of like opposed pliant fabric or leather side panels each spanning a space between a respective edge of said front panel and a respective edge of said back panel, said panels combining to define a seat cushion receiving opening there between; and
an upholstered cushioning seat panel spanning said seat cushion receiving opening and an upper edge of said cushioning front panel, said cushioning seat panel secured towards its front outer edge to a top of said cushioning front panel and towards each of said side outer edges to an upper edge of a respective one of said side panels, said upholstered cushioning seat panel comprising a fabric or leather outer and a soft filling;
wherein when said comfort seat cushion cover is placed over the at least one cuboid seat cushion, at least said front and side panels extend to or below a bottom of said cuboid seat cushion and such that the cuboid seat cushion is substantially no longer visible.

14. The comfort seat cushion cover of claim 13, wherein said seat depth extending cushioning front panel is selected to extend a depth of said seat assembly from between 2 inches and 5 inches.

15. The comfort seat cushion cover of claim 14, wherein the 16G certified divan is berthable and further wherein said seat depth extending cushioning front panel is selected to extend a depth of said seat assembly to a maximum of 3.5 inches.

16. The comfort seat cushion cover of claim 13, wherein said cushioning seat panel is secured towards a rear outer edge to an upper edge of said back panel.

17. The comfort seat cushion cover of claim 13, further comprising a releasable fastener for securely fastening said seat comfort cushion cover to the seat cushion.

18. The comfort seat cushion cover of claim 17, wherein said fastener comprises a two component hook and loop type fastener, wherein a first of said two components is attached to an underside of the seat cushion and a second of said two components is attached to a flap extending from a lower edge of each of said panels and further wherein said second components are engaged by said first components following insertion of said seat cushion into said seat cushion receiving opening and folding each of said flaps over an underside of the seat cushion.

19. A method of improving the comfort of a 16G certified divan, the divan comprising a plurality of seat cushions secured to a frame using a loop and hook type fastener:
removing each of the seat cushions from the frame;
providing a comfort seat cushion cover for each of the removed seat cushions, each of said covers comprising a seat depth extending cushioning front panel, a pliant fabric or leather rear panel and a pair of like opposed pliant fabric or leather side panels each spanning a space between a respective edge of said front panel and a respective edge of said back panel, said panels combining to define a seat cushion receiving opening there between, and a cushioning seat panel spanning said seat cushion receiving opening and an upper edge of said cushioning front panel, said cushioning seat panel secured towards its front outer edge to a top of said cushioning front panel and towards each of said side outer edges to an upper edge of a respective one of said side panels, said cushioning front panel comprising a foam core covered in a fabric or leather, said upholstered upper panel comprising a fabric or leather outer and a soft filling;
forming a plurality of cushion/cover assemblies by placing each of the seat cushions within said seat cushion receiving opening of a respective one of said plurality of comfort seat cushion covers; and
replacing said plurality of cushion/cover assemblies in their respective positions on the divan and with said seat depth extending cushioning front panels facing outwards;
wherein when said comfort seat cushion cover is placed over said at least one cuboid seat cushion, at least said front and side panels extend to or below a bottom of said cuboid seat cushion and such that the cuboid seat cushion is substantially no longer visible.

20. The method of claim 17, wherein each of the seat cushions and each of said comfort seat cushion covers comprises a two component hook and loop type fastener, wherein a first of said two components is attached to an underside of each of the seat cushion and a second of said two components is attached to a flap extending from a lower edge of each of said panels of each of said comfort seat cushion covers and further wherein said forming comprises folding each of said flaps over an underside of the seat cushion and engaging at least a portion of said first components with at least a portion of each of said second components.
